(19) United States
(12) Patent Application Publication
(10) Pub. No.: US 2025/0006008 A1
(43) Pub. Date: Jan. 2, 2025

(54) GAMING MACHINE WITH AWARD DROP FEATURE

(71) Applicant: LNW Gaming, Inc., Las Vegas, NV (US)

(72) Inventor: Paul CLARKE, Birmingham (GB)

(21) Appl. No.: 18/757,474

(22) Filed: Jun. 27, 2024

Related U.S. Application Data
(60) Provisional application No. 63/510,446, filed on Jun. 27, 2023.

(51) Int. Cl. G07F 17/32

(52) U.S. Cl. CPC G07F 17/3267

(57) ABSTRACT

Disclosed, in one example, includes gaming machine configured to present reels associated with a first array. The reels bear symbols. The gaming machine animates, in a second array positioned above the first array, vertical trails, each trail having a randomly-selected, variable number of secondary game symbols. A separate award symbol is positioned above each trail. The gaming machine conducts a series of game spins, where for each spin the reels land some of the secondary game symbols via the first array. The gaming machine clips a portion of symbols from one or more trails based on a number of matching ones of the secondary game symbols that landed via the first array. The gaming machine further animates a drop of an award symbol toward a win line at the bottom of the second array. If an award symbol reaches the win line, the game-logic circuitry awards an award value.

### CROSS-REFERENCE TO RELATED APPLICATION(S)

This patent application claims priority benefit of U.S. Provisional Patent Application No. 63/510,446 filed Jun. 27, 2023. The disclosure of the 63/510,446 application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD OF THE INVENTION

The present invention relates to a technological improvement to gaming systems, gaming machines, and methods thereon and, more particularly, to new and improved animations in connection with a bonus feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present disclosure, there is provided a gaming system, gaming machine, method, etc. to perform operations via game-logic circuitry. The gaming machine includes a presentation assembly configured to present a plurality of reels associated with a first array, said plurality of reels configured to bear a plurality of symbols. The operations include animating, in a second array positioned above the first array, a plurality of trails. Each trail from the plurality of trails has a variable number of trail symbols randomly selected according to a random number generator. The operations further include animating, via the second array above each trail, a separate one of a plurality of award symbols associated with a plurality of award values presented via a display of the gaming machine. The operations further include conducting a series of game spins of the plurality of reels, where for each of the series of game spins, spinning and stopping the plurality of reels to land a plurality of subsets of the plurality of symbols for presentation via the first array. The operations further include, in response to conducting each of the series of game spins, clipping a portion of trail symbols from one or more of the plurality of trails in the second array, wherein the portion of trail symbols clipped is equivalent to a number of matching ones of the plurality of subsets of the plurality of symbols that landed via the first array. The operations further include, in response to said clipping, animating a dropping motion of any given one of the plurality of award symbols positioned atop a clipped trail toward a win line at a bottom of the second array. Furthermore, the operations include, in response to detecting that the any given one of the plurality of award symbols reaches the win line, awarding one of the plurality of award values associated with the any given one of the plurality of award symbols.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present disclosure.

FIG. 2 is a block diagram of a gaming system according to an embodiment of the present disclosure.

FIG. 3 is a flow diagram for a data processing method that corresponds to instructions executed by game-logic circuitry, according to an embodiment of the present disclosure.

FIGS. 4-12 are an exemplary representation of a series of game cycle events and/or outcomes (i.e., spin outcomes) for a secondary feature according to an embodiment of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

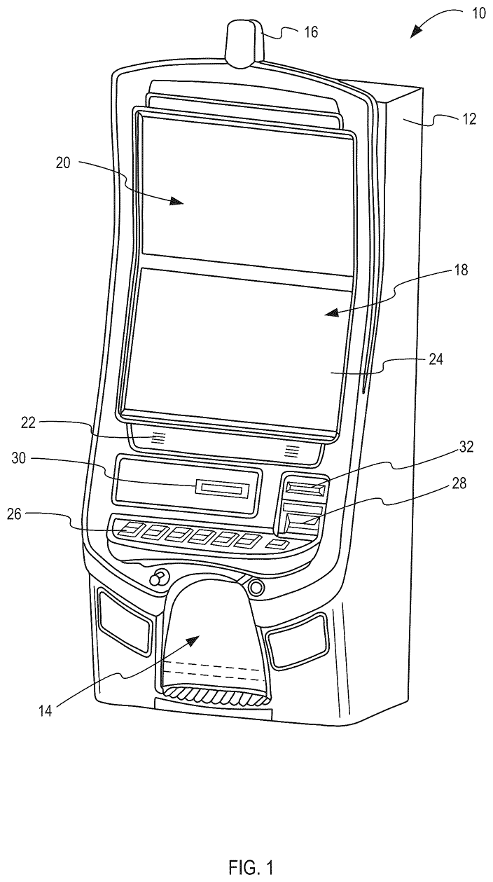

Referring to FIG. 1, there is shown a gaming machine 10 similar to those operated in gaming establishments, such as casinos. With regard to the present disclosure, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

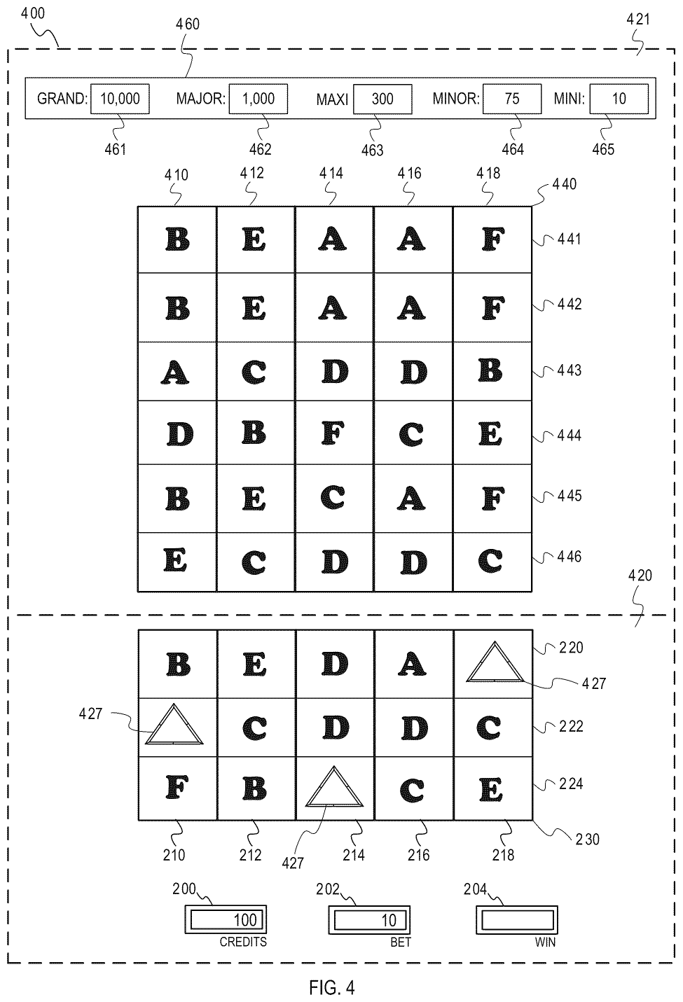

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIGS. 4-12). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the credits meter (e.g., credit meter 200, see FIGS. 4-12), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

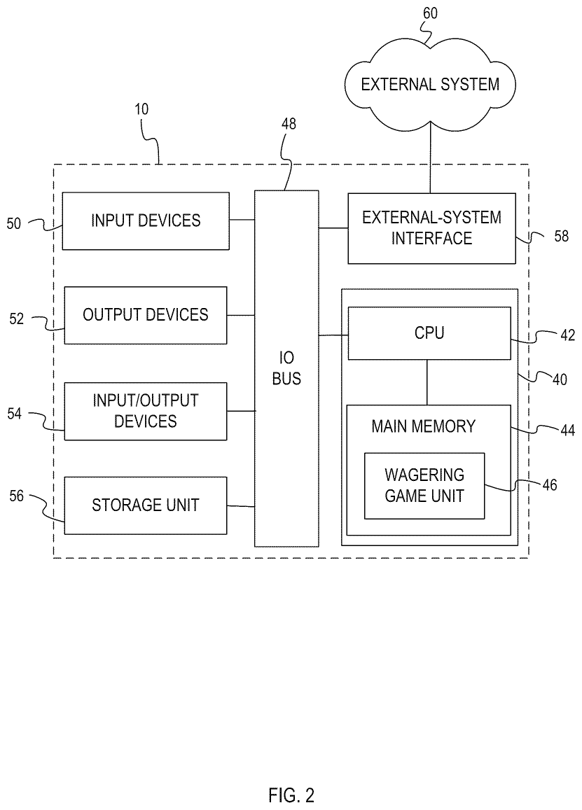

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

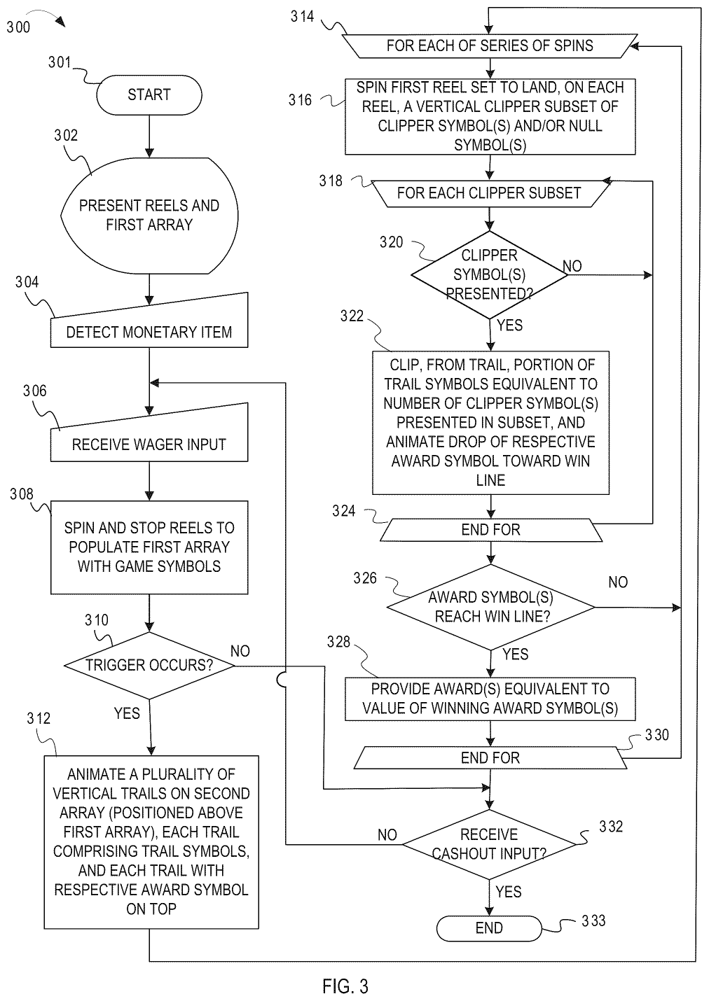

Referring now to FIG. 3, there is shown a flowchart representing one data processing method corresponding to at least some instructions stored and executed by the game-logic circuitry 40 in FIG. 2 to perform operations according to an embodiment of the present disclosure. The data processing method is described below in connection with an exemplary representation of a series of feature game cycles (including presentation of the game cycle/spin outcomes) in FIGS. 4-12.

The data processing method follows a flow 300, which commences at processing block 301. The flow 300 continues at processing block 302, where game-logic circuitry controls one or more presentation devices (e.g., mechanical-reel display device, video display device, or a combination thereof) that presents one or more pluralities of symbol-bearing reels and one or more arrays of symbol positions. The presentation associated with the method described herein may be performed by a presentation assembly including one presentation device or more than one presentation device. The symbol positions of each of the arrays may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position.

In example, the game-logic circuitry presents a first reel set configured to populate a first array (e.g., first array 230) with symbols and also presents a second reel set configured to populate a second array (e.g., second array 440) with symbols. In one embodiment, during the primary game, the first reel set and the second reel set present, via the first array and second array respectively, a first type of symbol (e.g., standard symbols). Standard symbols are associated with the primary game. In one embodiment, the first reel set is configured to present one or more special symbols, such as a special symbol that triggers a feature game (e.g., a secondary game). After a feature game is triggered, during the feature game spins (e.g., during secondary-game spins), the second reel set becomes static, and the second array is populated with a second type of symbol (e.g., secondary game symbols) that can persist state within the second array (e.g., remain present via the second array) between secondary-game spins. For example, the second array may be populated with vertical stacks of secondary game symbols, each stack having a variable height. The stacks may be referred to herein as “trails” and the height of the stacks may be referred to as a “length” of a trail. Further, the secondary game symbols in the trail may be referred to herein as trail symbols. The variable length trails include varying amounts of trail symbols that can, during the feature game, be clipped based on random appearance of certain secondary game symbols (referred to as “clipper” symbols) that are presented by the first reel set within the first array during spins of the feature game. The trail symbols and the clipper symbols can have a matching appearance (e.g., can be identical instances of the second type of symbol).

As shown in FIG. 4, the presentation device (e.g., presentation device(s) 400) presents (on a primary presentation device 420) the first array 230 (e.g., a primary game array), such as a three-by-five array comprising three rows 231, 232, 233 and five columns 210, 212, 214, 216, 218). Each column is associated with a respective reel such that the reel populates the three symbol positions in the associated column. The reels associated with the first array 230 may be referred to herein as the first reel set. The reels bear a plurality of symbols. In one embodiment, the plurality of symbols include standard symbols (e.g., A, B, C, D, E, and F). In one embodiment, the plurality of symbols also includes a special symbol, such as a special symbol 427 (e.g., a triangle). The standard symbols are used during primary-game spins to determine outcomes of the primary game (also referred to as the base game). During the primary game, a secondary game is triggered. In one embodiment, appearance of one or more of the special symbol 427 triggers the secondary game. After the secondary game is triggered, the first reel set and the second reel set are configured to present secondary game symbols. In some embodiments, the secondary game symbols include trail symbols (e.g., trail symbols 601, 602, 603, 604, 605—used to track heights/lengths of respective secondary game trails 611, 612, 613, 614, 615), clipper symbols (e.g., clipper symbols 701, 702, 703, 704, 705—used to clip heights/lengths of associated ones of the trails 611, 612, 613, 614, 615), null symbols (e.g., null symbol 715—used as part of a clipper subsets 711, 712, 713, 714, 715), and secondary game award symbols (e.g., award symbols 681, 682, 683, 684, 685—used to specify a secondary game award). Further description of the use of secondary game symbols is included in association with FIGS. 4-12. In some embodiments, the award symbols 681, 682, 683, 684, and 685 are associated with the values of jackpots for jackpot meters 461, 462, 463, 464, and 465 presented via the display(s) 400 prior to conducting the secondary game. In one embodiment, some of the award symbols are associated with progressive jackpot values. For example, the jackpots associated with jackpot meters 461 and 462 (i.e., the Grand and Major jackpots) are progressive jackpots that increase with every primary game played (e.g., jackpot meter 461 (for Grand) increases by 0.4% of wager, jackpot meter 462 (for Major) increases by 0.3% of wager). The jackpots associated with jackpot meters 463, 464, and 462 (i.e., the Maxi, Minor, and Mini) are static non progressives. In some embodiments, the non-progressive jackpots work on a stake multiplier so that if a bet stake is increased then so is the jackpot value. The progressive jackpots (e.g., the Grand and Major) do not increase with stake. Furthermore, in some embodiments different denominations can have their own jackpot values. In one embodiment, a maximum prize value for one or more of the progressive jackpots can be set to a given limit (e.g., set at a limited value such as $10,000, limited to a reset value of the progressive, etc.).

It should be noted that although this present description refers to one type of secondary game award or objective (i.e., a jackpot or pot value), other embodiments can utilize different types of secondary game awards or objectives, such as cash or credit awards, fixed prize awards, game play awards (e.g., a number of free spins, a picking game, a wheel spin), etc. Hence, in one embodiment, the symbol or object used to indicate the description or value of the secondary game award may be referred to generically as an award symbol. In some embodiments, the award symbols may include value-bearing symbols. In one example, a value-bearing symbol is associated with a credit or currency value indicated on the symbol itself. The value on a particular value-bearing symbol may be fixed or variable (e.g., random) from one game cycle to the next. Different value-bearing symbols on the reels may have different values. Each reel may contain one or more stacks (i.e., clumps) of value-bearing symbols that appear adjacent to each other along the reel. The values of the value-bearing symbols in any given stack may be the same or different. A stack of value-bearing symbols may consist of two, three, four, or more adjacent symbols. In some embodiments, the value-bearing symbols appear during the primary game and are persisted (e.g., added to a pot) for use during the secondary game. In some embodiments, value-bearing symbols may appear only on specific portions of an array. Furthermore, value-bearing symbols may be associated with one or more of a plurality of different types having different characteristics (e.g., colors, styles, sizes, text descriptions, special effects, ranges of value, etc.), which can be persisted in different types of containers (e.g., persisted in different pots of the different characteristics). Also shown in FIG. 4, the presentation device(s) 400 presents (either via the primary presentation device 420 or via a secondary presentation device 421) the second array 440. In some embodiments, the second array 440 functions, during a primary-game spin, as an additional primary game array and/or as an extension of the first array 230. For example, prior to the secondary game being triggered, the second array 440 is associated with a second reel set in which additional reels spin during the primary game and present standard symbols eligible for wins in the primary game. In some embodiments, reel outcomes associated with the first reel set can affect an outcome of the second reel set. For example, the primary game may also include one or more features that transfer an instance of a specific type of symbol or stack of symbols from a spin outcome by the first reel set to a spin outcome of the second reel set (e.g., transfer a stack or entire reel of a certain standard symbol that occurred via the first reel set to a corresponding reel in of the second reel set). In one embodiment, each column of the first array 230 is a separate reel. In other embodiments, each position (e.g., each entry) in the first array 230 can be a separate reel. In one embodiment, a specific position in the first array 230 can correspond to a respective position in the second array 440.

In the example shown in FIG. 4, the second array 440 is a different size than that of the first array 230. For example, the second array 440 is a six-by-five array comprising six rows (rows 441, 442, 443, 444, 445, and 446) and five columns (columns 410, 412, 414, 416, and 418). Each column is associated with a respective reel such that the reel populates the six symbol positions in the associated column. The reels bear a plurality of symbols. In one embodiment, the plurality of symbols include the standard symbols (e.g., A, B, C, D, E, and F), the special symbol 427, and secondary game symbols.

Returning to FIG. 3, after processing block 304, the flow 300 continues at processing block 304, where the game-logic circuitry detects, via a value input device, a physical item associated with a monetary value that establishes a credit balance. As shown in FIGS. 4-12, the credit balance may be shown on the credit meter 200 of the gaming machine. Furthermore, win amounts for a game event (e.g., a primary-game event, a secondary-game event, etc.), can be presented in a win meter 204.

The flow 300 continues at processing block 306, where the game-logic circuitry initiates a wagering game cycle in response to an input indicative of a wager covered by the credit balance. To initiate a spin of the reels, the player may press a “Spin” or “Max Bet” key on a button panel or touch screen. As shown in FIGS. 4-12, the wager may be shown on a bet meter 202.

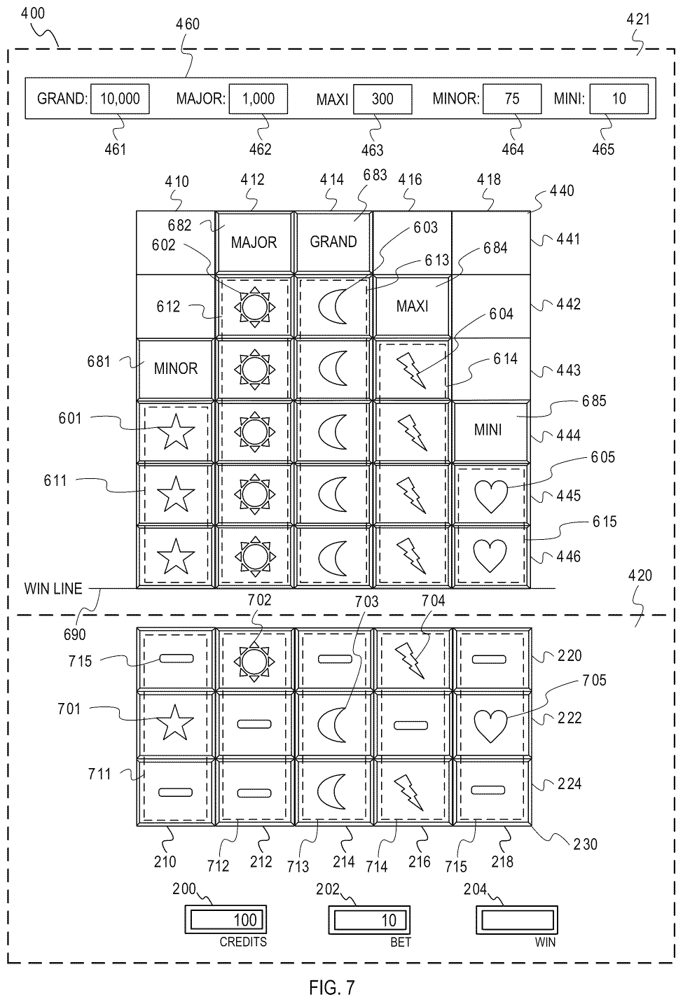

The flow 300 continues, at processing block 308, where, using an RNG, the game-logic circuitry spins and stops the reels to randomly land standard symbols on the first reel set (e.g., via first array 230) and from the second reel set (e.g., via second array 440) in visual association with one or more paylines (also known as lines, ways, patterns, or arrangements). The reel spins may be animated on a video display by depicting symbol-bearing strips moving vertically across the display and synchronously updating the symbols visible on each strip as the strip moves across the display. The reel spin may land the standard symbols as presented in the array 230 shown in FIG. 4. In one embodiment, for the primary game, both the first reel set and a second reel set are presented. In one embodiment, both reel sets are configured to present the special symbol 427. Both reel sets can include primary game symbols and at least some of the secondary game symbols. In one embodiment the first reel set is configured to present standard symbols, the special 427 symbol, and a first portion of secondary game symbols including clipper symbols and a null symbol. The second reel set is also configured to present standard game symbols and functions during the primary game as an additional reel set from which standard game symbols can be presented for an additional possible winning line of symbols for a reel-stop configuration. During the primary game, the first reel set and second reel set both spin (in response to a single bet/single value input) and produce results based on a random number generation. The second reel set is configured for play according to jurisdictional rules or constraints (e.g., the secondary reel is configured for play as a class 3 wagering game, such as a land-based casino slot game). Some interactions can occur between the first reel set and the second reel set (e.g., if one type of symbol appears in one reel set, that symbol may be transported to the secondary reel). The second reel set may also be configured to present special symbols (e.g., to trigger a secondary game). In one embodiment, the second reel set is further configured to present a portion of the secondary symbols, such as trail symbols and award symbols. In one embodiment, the trail symbols and clipper symbols can be related in appearance (e.g., see FIGS. 7-12).

In the example shown in FIG. 4, the second reel set is positioned above the first reel set such that each reel set has an equivalent number of reels (e.g., five reels) that are aligned vertically. The first reel set is 5×4 (e.g., five columns and four rows), each column being associated with a different one or the reels. The reels in the second reel set may be taller (e.g., the second reel set has a second array that has more entries for symbols). For instance, the second reel set is 5×N (e.g., five columns by N rows, where N>4), which each column being associated with a different one of the reels.

Referring again to FIG. 3, at processing block 310, the game-logic circuitry determines whether a secondary-game trigger occurs to begin the secondary game (also referred to herein as a “feature” game). For example, the secondary-game trigger can be a random mystery trigger (e.g., via the RNG). In another example, the secondary-game trigger is occurrence of a trigger symbol in the primary game, such as whether a threshold number of (e.g., at least one of) the special symbol 427 appears on any of the reels. In another embodiment, a secondary game trigger may include presentation of a specific number of special symbols. For instance, the secondary-game trigger may occur when three or more special symbols appear. In another example, the secondary-game trigger is an appearance of special symbols on a threshold number of the reels (e.g., a trigger occurs when special symbols appear on two or more reels). In another example, the secondary-game trigger can occur based on special symbols being oriented in a specific manner (e.g., in a specific direction or location, on three adjacent reels or along a specific pay line, etc.). In another example, the secondary-game trigger occurs in some other way (e.g., a specific secondary-game trigger symbol appears, a specific standard symbol appears (e.g., a wild symbol), etc.).

As mentioned, in one embodiment appearance of the special symbol 427 can be one type of a trigger for the secondary game. For example, the special symbol 427 may be positioned only on certain ones of the reels (e.g., the special symbol 427 only appears on the first, third, and fifth reels on both reel sets). In some embodiments, the trigger for the secondary game may require appearance of a certain number of the special symbol 427 or, in some instances, the special symbol 427 may trigger the secondary game based on RNG. For instance, if three or more of the special symbol 427 appear a secondary game is automatically triggered. However, if fewer than three of the special symbol 427 appear, it could trigger a secondary game or may not trigger a secondary game. For example, in response to appearance of one special symbol 427, the game-logic circuitry can present a special effect, such as shooting up sparkles from the special symbol 427. When the sparkles reach a specific coordinates on the display screen (e.g., when they reach a primary-game title displayed via the presentation device(s) 400) a second special effect occurs to indicate whether or not the secondary game had been triggered. For example, if, based on RNG, the secondary game is not triggered, the second special effect may be a first type (e.g., near-miss type), which pulses once but does not trigger the secondary game. On the other hand, if the secondary game is triggered, the second special effect may be a second type (e.g., a game-trigger type) which pulses repeatedly and initiates audio and visual presentation of the secondary game. In some embodiments, in response to the secondary game being triggered, the game-logic circuitry can highlight the values specified in the jackpot meters 461, 462, 463, 464, and 465, and, in some instances, can increase or upgrade (i.e., add to) the values. In one embodiment, the increased add to the jackpot value remains in the jackpot until it is won. In one embodiment, each stake can have its own jackpot levels that can remain until the jackpot is won.

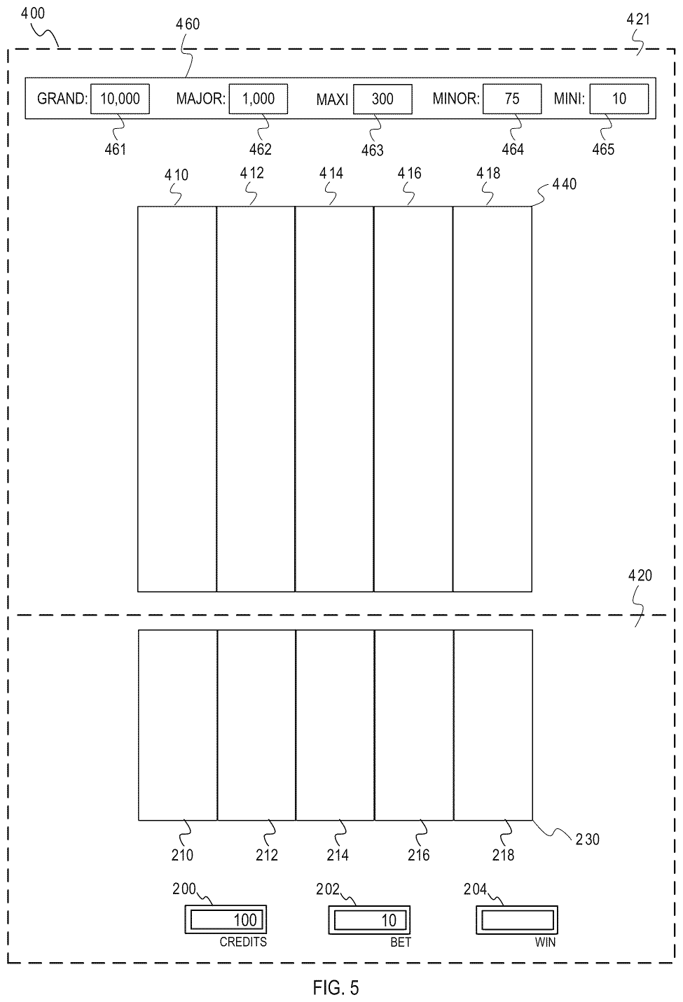

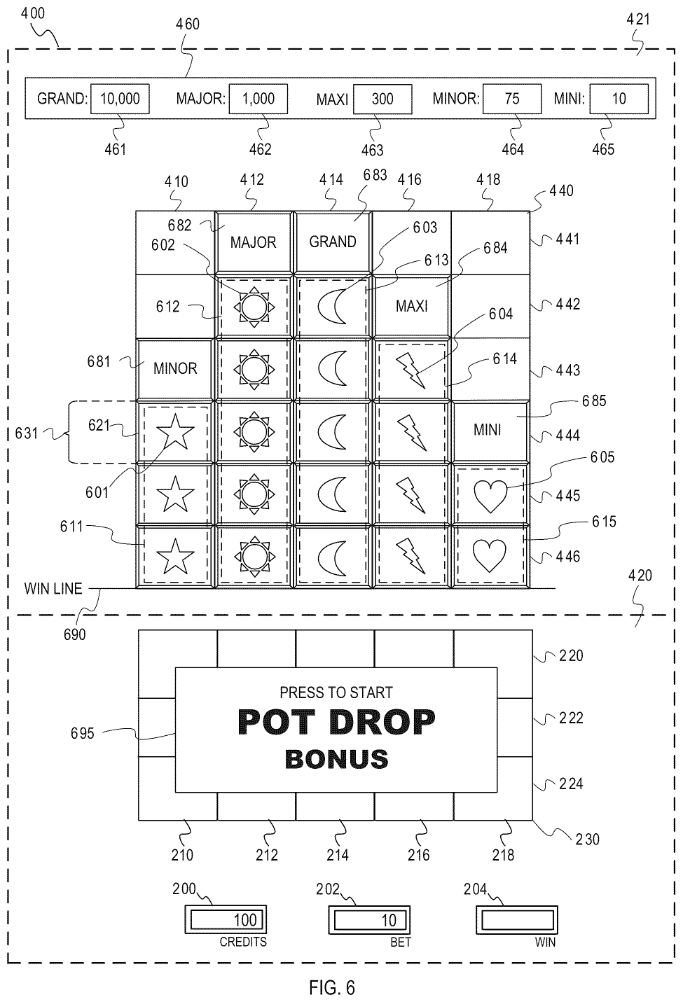

If, at processing block 310, the secondary game is not triggered, the game-logic circuitry immediately proceeds to processing block 332. If, however, the secondary game is triggered, the game-logic circuitry proceeds to processing block 312 where the game-logic circuitry animates a plurality of vertical trails on the second array 440, each trail comprising trail symbols, and each trail with a respective award symbol on top. For example, as shown in FIG. 5, in response to detecting that the secondary game is triggered, the game-logic circuitry removes the standard symbols (and/or any special symbols) from the first array 230 and the second array 440. As shown in FIG. 6, after the standard symbols and special symbol(s) have been removed, the game-logic circuitry causes the second array 240 to be populated with a plurality of trails (trails 611, 612, 613, 614, and 615), with each trail including a variable number of trail symbols selected from the secondary game symbols. In some embodiments, the trail symbol is a graphical object (e.g., a graphical block of stone) that appears to fill an entire entry (e.g., cell) of the second array 440. The graphical object also includes the image of the trail symbol. For example, the game-logic circuitry fills entry 621 (and other entries for the trail 611) with a graphical object having a star-shaped image (symbol 601) with a height 631 that is equivalent to the height of the entry 621. Thus, in one embodiment, the animated objects for the trail symbols appear to be stacked upon each other. When one of the graphical objects for a trail symbol is clipped from a bottom of a trail (e.g., see processing block 322), the remainder of the graphical objects stacked above it (e.g., the remaining, non-clipped trail symbols and the respective award symbol) appear to drop downward (vertical drop) toward the win line 690, as if falling due to a downward gravitational pull that acts on the stack of non-clipped trail symbols after the removal of the clipped trail symbols. Consequently, as illustrated in FIG. 7, the second reel set does not function as reels for the secondary game, but rather the second array 440 includes trails of symbols to be removed based on a number of clipper symbols randomly presented on the first array 230 during spins of the secondary game. In one embodiment, each trail has a variable, randomly selected length (height) at the start of the bonus (randomly selected by random number generation) based on the number of trail symbols included in the trail. In other words, the number of trail symbols (e.g., animated block objects) in each trail are randomly selected, thus the size (e.g., height/length) of each trail can potentially be different from the size of any other trail. Because each trail has a variable size (height/length), shorter trails convey the anticipatory visual effect that a jackpot win is more likely for a shorter trail than a longer trail (given the lower number of trail symbols within the shorter trail). The trail size can be decided by a math spreadsheet associated with odds for the secondary game.

The game-logic circuitry further positions at least one award symbol atop each of the trails 611, 612, 613, 614, and 614. For example, the award symbol 681 (for the Minor jackpot) is animated to sit atop the trail 611. The award symbol 682 (for the Major jackpot) is animated to sit atop the trail 612. The award symbol 683 (for the Grand jackpot) is animated to sit atop the trail 613. The award symbol 684 (for the Maxi jackpot) is animated to sit atop the trail 614. The award symbol 685 (for the Mini jackpot) is animated to sit atop the trail 615. Each of the award symbols 681, 682, 683, 684, 685 has an identifier (e.g., textual, graphical, etc.) that identifies the particular jackpot (e.g., the textual identifier “MINOR” is associated with the jackpot meter 464 and the award symbol 681, the textual identifier “MAJOR” is associated with the jackpot meter 462 and the award symbol 682, the textual identifier “GRAND” is associated with the jackpot meter 461 and the award symbol 683, the textual identifier “MAXI” is associated with the jackpot meter 463 and the award symbol 684, and the textual identifier “MINI” is associated with the jackpot meter 465 and the award symbol 685).

After processing block 312, the flow 300 continues at processing block 314 where the game-logic circuitry begins a first loop. Each instance of the first loop occurs for each spin of a series of spins (e.g., for the secondary game). In one embodiment, prior to conducting the series of spins (e.g., secondary-game spins), the game-logic circuitry can prompt the player to start the secondary game (e.g., via prompt message 695), such as by pressing a touch screen, by activating a physical button on the gaming machine, etc. The first loop includes the processing blocks 316 through 330 and either repeats (at processing block 316) or ends (at processing block 330) based on whether termination criteria for the loop has been met or not (e.g., termination criteria can include when an award symbol (atop one of the trails in the second array 440) reaches win line 690 (e.g., see processing block 326)). The loop begins with a first of the secondary-game spins. The loop ends after a last secondary-game spin completes, for example when termination criteria is met. A second loop is a subloop of the first loop (i.e., the second loop occurs within the first loop). The second loop comprises the processing blocks 318 through 324.

Referring back to the first loop, the flow 300 continues, at processing block 316, where the game-logic circuitry spins the first reel set to land, on each reel in the first reel set, a vertical clipper subset of secondary game symbols. For example, as shown in FIG. 7, the game-logic circuitry spins the first reel set and populates each of the reels in the first reel set with a different one of a plurality of clipper subsets 711, 712, 713, 714, 715. Each clipper subset is constructed by randomly selecting (e.g., via a random number generator) from either a clipper symbol or a null symbol for placement in each entry/cell of each given reel in the first array 230. In one embodiment, the secondary game symbols for trail symbols and clipper symbols are selected from a set of distinct symbols, where each member of the set of distinct symbols has a different identifier (e.g., name, image, etc.) from any other member. Furthermore, animating the plurality of trails can include using, for the variable number of trail symbols for each of the plurality of trails, a separate one of the set of distinct symbols. For instance, the first reel set functions as reels for the secondary game, which reels contain graphical objects (e.g., blocks) depicting clipper symbols (e.g., pictured game symbols) and null symbols (e.g., dash symbols). Clipper symbols are symbols that are used to activate the progress of the secondary game by triggering elimination of trail symbols from the trails. In one embodiment, the clipper symbols include a set of distinct symbols (e.g., a set of distinct pictures, identifiers, etc.), which set of distinct symbols are associated with the set of distinct symbols used in the trails. For example, as shown in FIG. 7, trail 611 includes only instances of a first secondary game symbol having a first, distinct picture (e.g., star-shaped, symbol 601). Trail 611 includes three pictured blocks of the star-shaped, symbol 601. Clipper subset 711 (below trail 611) includes, for clipper symbol 701, the same distinct star-shaped image as for symbol 601. Trail 612 includes only instances of a second secondary game symbol having a second, distinct picture (e.g., sun-shaped, symbol 602). The trail 612 includes five pictured blocks of the sun-shaped, symbol 602. Clipper subset 712 (below trail 612) includes, for clipper symbol 702, the same distinct sun-shaped image as for symbol 602. The third, fourth, and fifth trails also include instances of different distinct symbols (e.g., the trail 603 includes five pictured blocks of moon-shaped, symbol 683; the trail 614 includes four pictured blocks of lighting-shaped, symbol 604; the trail 615 includes two pictured blocks of heart-shaped, symbol 605). Clipper subset 713 (below trail 613) includes, for clipper symbol 703, the same distinct moon-shaped image as for symbol 603. Clipper subset 714 (below trail 614) includes, for the clipper symbol 704, the same distinct lighting-shaped image as for symbol 604. Clipper subset 715 (below trail 615) includes, for the clipper symbol 705, the same distinct heart-shaped image as for symbol 605.

More specifically, the reel to the far left of array 230 and array 440 (i.e., the reels for column 410 and the column 210) use the same type of symbol (i.e., a star-shaped symbol) as both the trail symbol 601 as well as the clipper symbol 701. Each separate column can use a separate one of the distinct symbols. For example, the reels for column 212 and 412 use the matching sun-shaped symbol as both the trail symbol 602 and the clipper symbol 702. The reels for column 214 and column 414 use the matching moon-shaped symbol as both the trail symbol 603 and the clipper symbol 703. The reels for column 216 and column 416 use the matching lightning-shaped symbol as both the trail symbol 604 and the clipper symbol 704. The reels for column 218 and column 418 use the matching heart-shaped symbol as both the trail symbol 605 and the clipper symbol 705. The game-logic circuitry animates each clipper subset to include a combination of either clipper symbols or null symbols. Each clipper subset can have a variable number of clipper symbols. For example, the clipper subset 711 includes one randomly selected clipper symbol (i.e., symbol 701) and two randomly selected null symbols; the clipper subset 712 includes one randomly selected clipper symbol (i.e., symbol 702) and two randomly selected null symbols; the clipper subset 713 includes two randomly selected clipper symbols (i.e., two of symbol 703) and one randomly selected null symbol; the clipper subset 714 includes two randomly selected clipper symbols (i.e., two of symbol 704) and one randomly selected null symbol; the clipper subset 715 includes one randomly selected clipper symbol (i.e., symbol 705) and two randomly selected null symbols. In one embodiment, the null symbol (e.g., symbol 715) does not trigger elimination of trail symbols, can be used for one or more award features that are not associated with the award symbols 681, 682, 683, 684, or 685. For instance, in some embodiments, the null symbol can be game symbols that can provide an award. For example, null symbols can be standard game symbols, value-bearing symbols, etc. Hence, if, during the secondary game spin, a reel-stop configuration of the reels in the first reel set presents a given outcome that would result in a win in the primary game (e.g., the reel-stop configuration lines up standard game symbols according to a winning configuration described in a pay table of the primary game), then the secondary game can provide an additional award associated with the winning configuration.

Referring back to FIG. 3, the flow 300 continues at processing block 318, where the game-logic circuitry initiates the second loop where, for each clipper subset the game-logic circuitry performs operations of at least processing block 320 and, based on the determination at processing block 320, further includes processing block 322. For example, at processing block 320, the game-logic circuitry determines whether a clipping condition is met, such as whether a clipper symbol randomly appeared in the clipper subset. If a clipping condition occurs (e.g., a clipper symbol is present in the clipper subset), then the flow 300 continues at processing block 322, where the game-logic circuitry clips (i.e., removes), from a trail (e.g., a corresponding trail directly above the clipper subset, a corresponding trail having a trail symbol that matches the clipper symbol, etc.), at least a portion of trail symbols equivalent to a number of clipper symbols presented in the corresponding clipper subset.

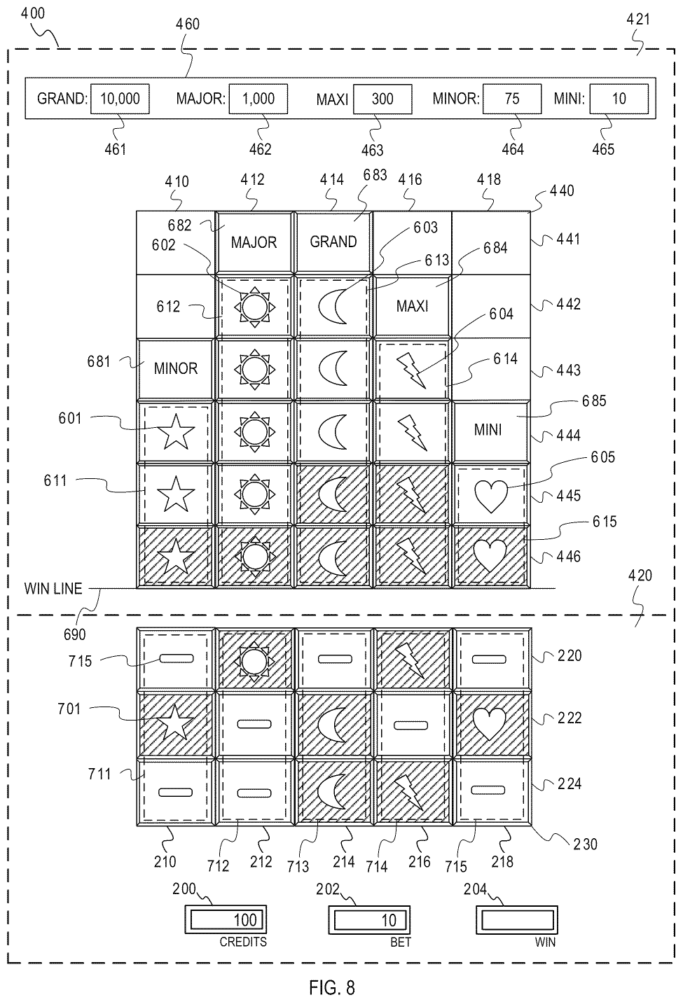

The game-logic circuitry further animates a drop (e.g., presents an animated dropping effect) of a respective award symbol atop the clipped trail toward a win line at the bottom of the trail. The second loop then repeats (at processing block 318 through 324) for all of the remaining clipper subsets. For example, in FIG. 8, each clipper symbol that lands on a reel in the first array 230) will eliminate an equivalent (i.e., matching) block from a trail in the second array 440, such as from a trail directly above the corresponding reel. For example, each clipper symbol is highlighted on the corresponding reel where it appeared. Subsequently (or simultaneously) a bottom trail symbol is highlighted in the trail directly above the corresponding reel and then clipped/removed (e.g., smashed) from the bottom of the trail causing the trail to drop down-effectively making the trail smaller and bringing a corresponding award symbol atop the trail closer to the win line 690 at the bottom of the trail (e.g., the win line 690 is a horizontal line at the bottom of the second array 440, which horizontal line coincides with the bottom of all trails 611, 612, 613, 614, 615).

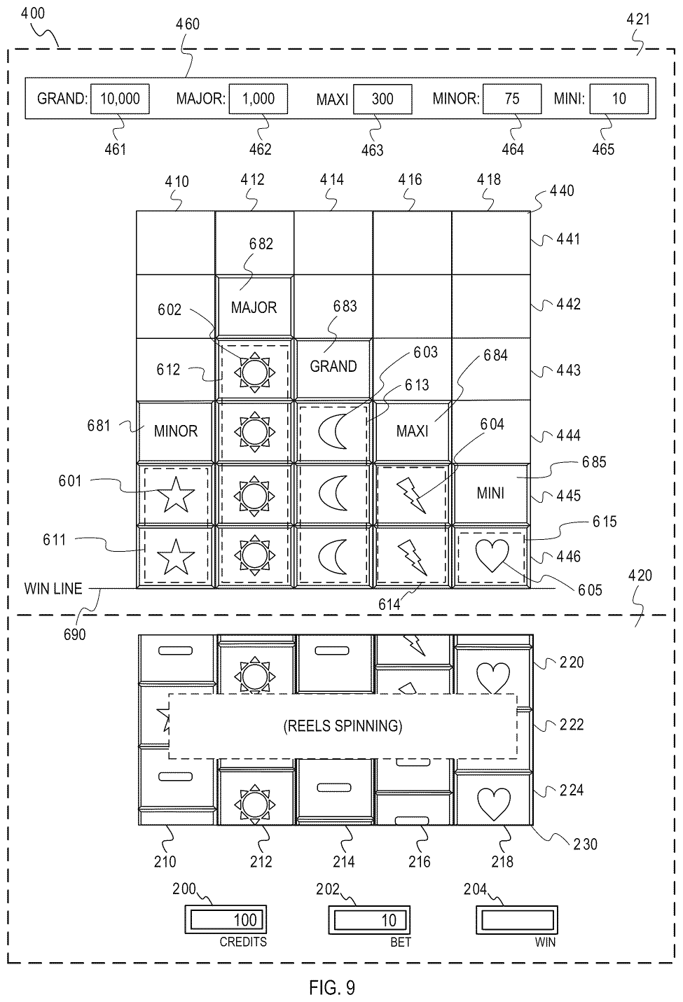

Referring back to FIG. 3, the second loop (i.e., processing blocks 318 through 324) is only one example of clipping trail symbols. In another embodiment, the game-logic circuitry can clip trail symbols according to a different pattern or timing. For example, as shown in FIG. 8, the game-logic circuitry can, prior to clipping any trail symbols, first detect all of the clipper symbols that appeared in all of the clipper subsets 711, 712, 713, 714, 715. Subsequently, the game-logic circuitry highlights all of the clipper symbols 701, 702, 703, 704, and 705 that appeared within the first array 230. Next, the game-logic circuitry highlights all of the corresponding trail symbols to be clipped from the bottom of the trails 611, 612, 613, 614, and 615. Then, the game-logic circuitry concurrently and/or collectively clips the highlighted trail symbols from of the trails 611, 612, 613, 614, and 615. After the trails 611, 612, 613, 614, and 615 are clipped, the game-logic circuitry can concurrently and/or collectively animate the drop of any of the award symbols 681, 682, 683, 684 or 685 associated with a clipped trail. For example, as illustrated in FIG. 9, the trails 611, 612, 613, 614, and 615 have been clipped.

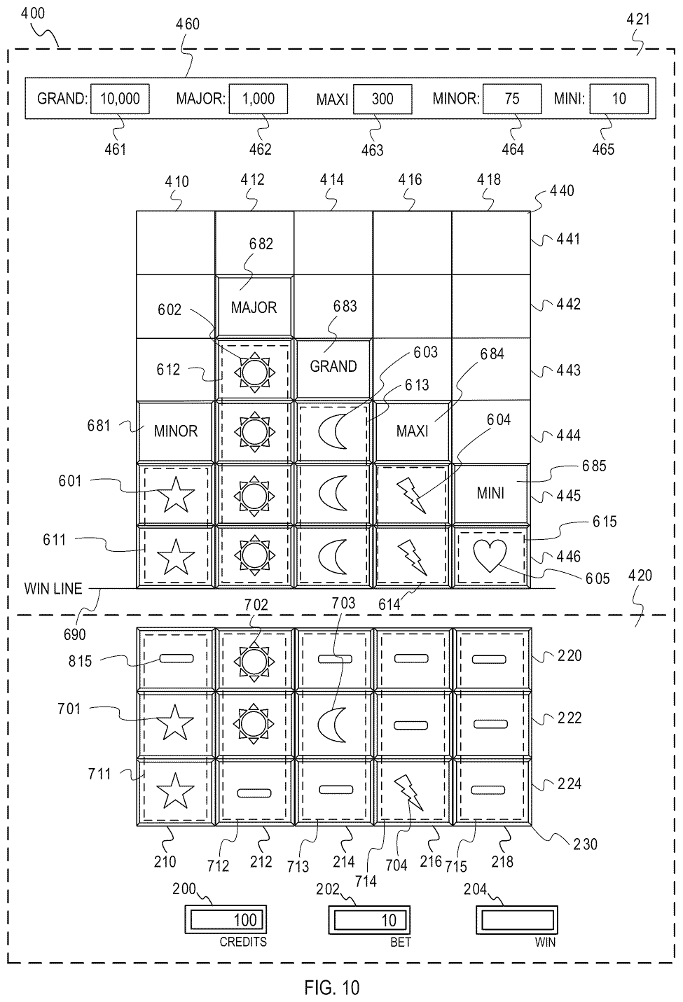

Referring back to FIG. 3, the flow 300 continues at processing block 326, where the game-logic circuitry determines, after performing the second loop, whether an award symbol reaches the win line. In some embodiments, multiple award symbols can reach a win line simultaneously. If, at processing block 326, the game-logic circuitry determines that an award symbol reached the win line, then at processing block 328, the game-logic circuitry provides award(s) equivalent to a value for the award symbol(s). After the first secondary-game spin occurs (e.g., see FIG. 7 and FIG. 8), the game-logic circuitry determines, based on the state of the trails 611, 612, 613, 614, and 614 shown in FIG. 9, that none of the award symbols 681, 682, 683, 684, or 685 have reached the win line 690. Thus, the first loop in flow 300 returns to processing block 314 for a second secondary-game spin. The second secondary-game spin, as illustrated in FIG. 9, spins the first reel set again to randomly select and position secondary game symbols on the first array 230 as updated clipper subsets 711, 712, 713, 714, and 715 as shown in FIG. 10. During the second secondary-game spin, the second array 440 persists the clipped size of the trails 611, 612, 613, 614, 615 within the second array 440 (e.g., the trails 611, 612, 613, 614, 615 do not receive additional trail symbols, rather they persist their clipped states). The spin outcome of the second secondary-game spin results, (as shown in FIG. 10) in additional random outcomes that appear as updated members of the clipper subsets 711, 712, 713, 714, 715. For example, the outcome of the second secondary-game spin results in the following: clipper subset 711 includes two randomly-selected clipper symbols 701 and one randomly-selected null symbol 815, clipper subset 712 includes two randomly-selected clipper symbols 702 and one randomly-selected null symbol 815, clipper subset 713 includes one randomly-selected clipper symbol 703 and one two randomly-selected null symbols 815, clipper subset 714 includes one randomly-selected clipper symbol 704 and two randomly-selected null symbols 815, and clipper subset 715 includes three randomly-selected null symbols 815.

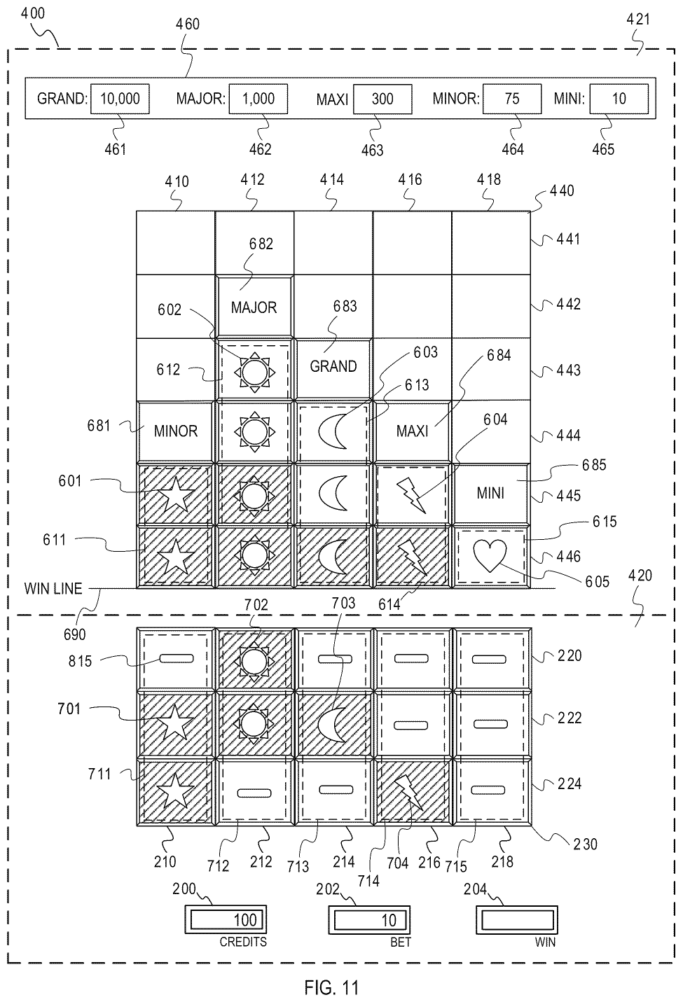

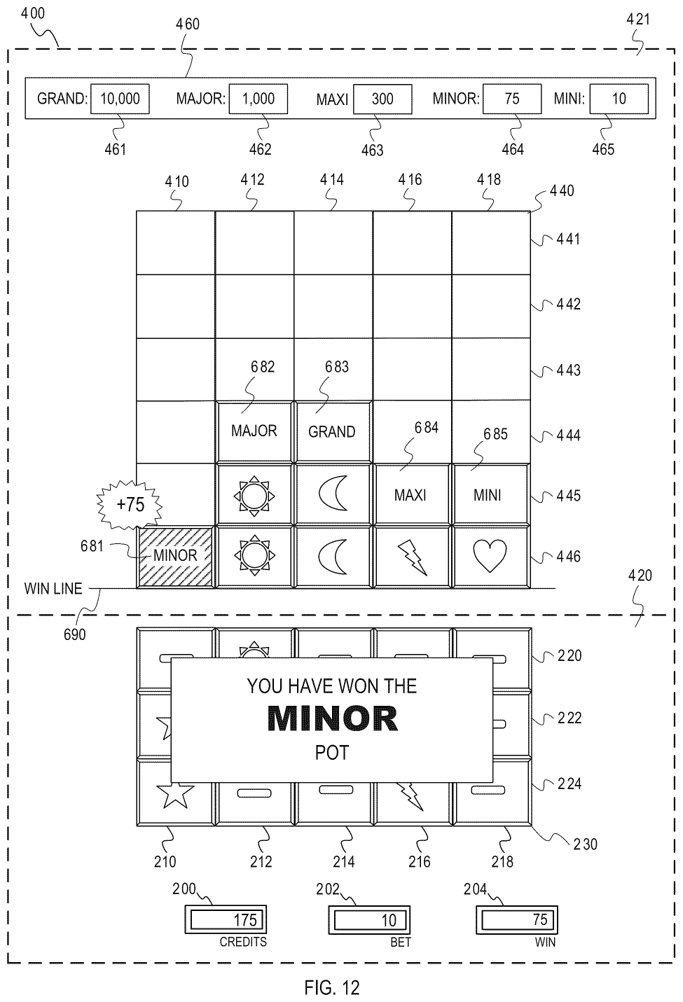

The game-logic circuitry re-valuates the outcomes of the updated clipper subsets 711, 712, 713, 714, 715 during the second loop (starting at processing block 318) where, (at processing block 320), the game-logic circuitry determines, for each clipper subset, whether any clipper symbols were presented (processing block 320), and if so, then performs processing block 322 to clip, from any associated trail, a portion of the trail symbols equivalent to a number of clipper symbols in the clipper subset. Further, the game-logic circuitry animates a corresponding drop of award symbols atop any clipped trails. As mentioned, in one embodiment, the game-logic circuitry can detect all of the clipper symbols in all clipper subsets and can highlight all matching trail symbols to be clipped prior to performing the clipping animation of the associated trails. The game-logic circuitry can then clip the associated trails concurrently according to the number of clipper symbols in the respective clipper subsets prior to performing the dropping animation of the respective award symbols atop the trails. After clipping the associated trails, the game-logic circuitry can then animate the drop of any award symbols atop any of the clipped trails (as well animating a drop of as any remaining trail symbols in the clipped trail). As shown in FIG. 11, the clipper subset 711 includes two of the clipper symbols 701, hence the game-logic circuitry highlights the two clipper symbols 701 and an associated number of trail symbols (two trail symbols 601) from the bottoms of a respective trail (e.g., from the bottom of trail 611). The secondary symbols to be clipped are first highlighted collectively, then clipped simultaneously. The game-logic circuitry also animates the dropping of each of the associated award symbols simultaneously after animating the collective clipping. In some embodiments, multiple award symbols may reach the win line 690 simultaneously, thus awarding (at processing block 328) multiple awards. In the example illustrated in FIG. 12, only one of the award symbols reaches the win line (i.e., the award symbol 681 associated with the “MINOR” jackpot value shown in jackpot meter 464). Hence, the game-logic circuitry awards a win amount (e.g., as shown in win meter 204) of the amount indicated in the jackpot meter 464. The game-logic circuitry updates the credit meter 200 with the won amount. After an award (e.g., a pot) is won, the game-logic circuitry can restore the first reel set and second reel set to their primary-game states, such as by causing the first reel set and the second reel set to present standard symbols during one or more subsequent primary-game spins. Furthermore, the game-logic circuitry can reset the value of any jackpot that was won to a predetermined reset value. In another embodiment, after the award is won (e.g., after processing block 330) instead of ending the secondary game, the game-logic circuitry can return to processing block 312 to reset the secondary game feature for continued play, such as by resetting the variable length trails and then repeating operations of the first loop (e.g., via processing blocks 314 through 330), until an additional termination criterion is met (e.g., after a certain number of secondary game spins occurs, after a certain degree of award is won, etc.). In some embodiments, the game-logic circuitry can reset and/or extend the secondary game feature based on a specific detected condition of the primary game (e.g., the secondary game feature is configured to reset and/or extended if a maximum bet (“max bet”) was placed during the triggering primary-game spin).

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the secondary being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence. For example, in one embodiment (e.g., as shown in FIG. 3), game-logic circuitry determines whether a feature game (e.g., secondary game) is triggered (e.g., at processing block 310). However, in another embodiment, the game-logic circuitry presents trail symbols in the second array (positioned over the first array), which persists over multiple primary-game spins. The second array can be populated with variable length trails, which persist in the second array over the multiple primary-game spins. During a primary-game spin, a number of clipper symbols can appear on a reel, in response to which, the game-logic circuitry can clip an equivalent number of trail symbols from a trail (e.g., from a corresponding trail above the clipper symbol(s)). The game-logic circuitry can animate a correlated dropping motion of symbols, within a clipped trail, toward a win line. The game-logic circuitry can further determine whether an award symbol, positioned atop a trail, reaches the win line and, if so, can award the amount associated with the award symbol. Once awarded, the game-logic circuitry can automatically reset the feature game to a beginning state by randomly re-selecting (via RNG) trail lengths for the trails in the second array. The game-logic circuitry can use the RNG outcome to determine the number of clipper symbols, and their positions relative to the trails, during the series of primary-game spins. In some embodiments, the game-logic circuitry can use a separate RNG outcome for each instance of clipper symbol presented.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A system comprising:
a gaming machine including a presentation assembly configured to present a plurality of reels associated with a first array, said plurality of reels configured to bear a plurality of symbols; and
game-logic circuitry configured to perform operations comprising:
animating, in a second array positioned above the first array, a plurality of trails, wherein each trail from the plurality of trails has a variable number of trail symbols randomly selected according to a random number generator;
animating, via the second array above each trail, a separate one of a plurality of award symbols associated with a plurality of award values presented via a display of the gaming machine;
conducting a series of game spins of the plurality of reels, wherein for each of the series of game spins, spinning and stopping the plurality of reels to land a plurality of subsets of the plurality of symbols for presentation via the first array;
in response to conducting each game spin, clipping a portion of trail symbols from one or more of the plurality of trails in the second array, wherein the portion of trail symbols clipped is equivalent to a number of matching ones of the plurality of subsets of the plurality of symbols that landed via the first array;
in response to said clipping, animating a dropping motion of any given one of the plurality of award symbols positioned atop a clipped trail toward a win line at a bottom of the second array; and
in response to detecting that the any given one of the plurality of award symbols reaches the win line, awarding one of the plurality of award values associated with the any given one of the plurality of award symbols.

2. The system of claim 1, wherein the game-logic circuitry is configured to present, via the display, the plurality of award symbols is association with a plurality of jackpot values, wherein the one of the plurality of award values associated with the respective one of the plurality of award symbols is one of the plurality of jackpot values.

3. The system of claim 2, wherein a first portion of the plurality of jackpot values are progressive jackpots that increase with each of a series of primary-game spins, and wherein a second portion of the plurality of jackpot values are static non-progressive jackpots having a value based on one or more of a stake multiplier or a denomination value associated with the gaming machine.

4. The system of claim 1, wherein a number of the plurality of award symbols is equal to a number of the plurality of reels, wherein each one of the plurality of reels is associated with a vertical column, and wherein each trail and the separate one of the plurality of award symbols atop each trail, are aligned in the vertical column.

5. The system of claim 4, wherein the game-logic circuitry configured to perform the clipping the portion of trail symbols from the one or more of the plurality of trails in the second array, is configured to perform operations comprising clipping some of the portion of trail symbols from a bottom of one of the plurality of trails aligned in the vertical column, wherein the one of the plurality of trails corresponds to one of the plurality of reels upon which the number of matching ones of the plurality of subsets of the plurality of symbols landed.

6. The system of claim 5, wherein the game-logic circuitry is further configured to perform operations to, in response to the clipping, animating a correlated dropping motion of all remaining trail symbols in the one of the plurality of trails after the some of the portion of trail symbols are clipped, causing the given one of the plurality of award symbols associated with the one of the plurality of trails, as well as the remaining trail symbols, to appear to drop downward toward the win line.

7. The system of claim 1, wherein the plurality of symbols comprise a set of distinct symbols, wherein each member of the set of distinct symbols has a different identifier from any other member, wherein animating the plurality of trails comprises using, for the variable number of trail symbols for each trail, a separate one of the set of distinct symbols.

8. The system of claim 7, wherein each of the plurality of subsets of the plurality of symbols is equivalent, in appearance, to a respective one of the set of distinct symbols used for each trail.

9. The system of claim 1, wherein the game-logic circuitry is further configured to perform operations comprising:
spinning and stopping the plurality of reels for a spin of a primary game to land primary game symbols of the plurality of symbols for presentation via the first array for a primary game; and
in response to detecting a trigger event, triggering a secondary game, wherein the game-logic circuitry is configured to perform, during the secondary game, the operations of animating the plurality of trails, animating the separate one of the plurality of award symbols above each trail, and conducting the series of game spins, wherein the plurality of subsets of the plurality of symbols comprise secondary game symbols different from the primary game symbols.

10. A method of operating a gaming machine, the method comprising:
presenting, by a presentation assembly, a reel set configured to land game symbols in a first array;
animating, in a second array positioned above the first array, a plurality of trails, wherein each one of the plurality of trails has a variable number of trail symbols;
animating, via the second array above each one of the plurality of trails, a separate one of a plurality of award symbols;
conducting, by game-logic circuitry a series of game spins of the reel set, wherein for each of the series of game spins, the method comprising:
animating, via the first array based on random number generation, a plurality of clipper subsets presented via the reel set, wherein each clipper subset from the plurality of clipper subsets is a vertical stack of symbols positioned below a separate one of the plurality of trails, and wherein each clipper subset comprises, based on random number generation, a collection of symbols selected from a group consisting of a clipper symbol and a null symbol;
detecting a number of clipper symbols presented in each clipper subset;
for each given clipper subset that presents at least one clipper symbol,
clipping, from at least one of the plurality of trails associated with the given clipper subset, at least a portion of the variable number of trail symbols equivalent to the detected number of clipper symbols presented in the given clipper subset, and
after said clipping, animating a correlated dropping motion of a respective one of the plurality of award symbols positioned atop the at least one of the plurality of trails that was clipped, wherein the correlated dropping motion is toward a win line at a bottom of the second array; and
in response to detecting that any one of the plurality of award symbols reaches the win line, awarding a game award equivalent to a value associated with the any one of the plurality of award symbols.

11. The method of claim 10, further comprising presenting, via a display of the gaming machine, the plurality of award symbols in association with a plurality of jackpot values, wherein the value associated with the respective one of the plurality of award symbols is one of the plurality of jackpot values.

12. The method of claim 11, wherein a first portion of the plurality of jackpot values are progressive jackpots that increase with each of a series of primary-game spins, and wherein a second portion of the plurality of jackpot values are static non-progressive jackpots having a value based on one or more of a stake multiplier or a denomination value associated with the gaming machine.

13. The method of claim 10, wherein the clipper symbols and the trail symbols comprise a set of distinct symbols, where each member of the set of distinct symbols has a different image from any other member, wherein animating the plurality of trails comprises using, for the variable number of trail symbols for each of the plurality of trails, a separate one of the set of distinct symbols.

14. The method of claim 13, wherein a clipper symbol for each clipper subset is equivalent, in appearance, to a corresponding one of the set of distinct symbols used for the respective one of each of the plurality of trails.

15. The method of claim 10, wherein the at least one of the plurality of trails associated with the given clipper subset is the separate one of the plurality of trails below which the given clipper subset is positioned.

16. The method of claim 15, wherein the clipping comprises clipping the at least a portion of the variable number of trail symbols from a bottom of the separate one of the plurality of trails.

17. The method of claim 10 further comprising: in response to said clipping, animating a correlated dropping motion of all remaining trail symbols in the at least one of the plurality of trails, causing the respective one of the plurality of award symbols associated with the at least one of the plurality of trails, as well as the remaining trail symbols, to appear to drop downward toward the win line by a combined height of the at least a portion of the variable number of trail symbols that was clipped.

18. The method of claim 10 further comprising:
presenting, by the presentation assembly, an additional reel set to land symbols via the second array prior to conducting the series of game spins, wherein the reel set and the additional reel set each include an equivalent number of reels, wherein the reel set and the additional reel set are configured to bear primary game symbols during a primary-game spin and to bear secondary game symbols during the series of game spins;
conducting, by the game-logic circuitry in response to detection of a user input via a value-input device of the gaming machine, at least one primary-game spin of one or more of the reel set and the additional reel set for a primary game, the at least one primary-game spin including spinning and stopping the one or more of the reel set and the additional reel set to land, via one or more of the first array or the second array, at least a portion of the primary game symbols; and
in response to detection of a trigger event, clearing the first array and the second array of the at least a portion of the primary game symbols, and animating, in the second array, the plurality of trails.

19. The method of claim 18, wherein a number of the plurality of award symbols match the number of reels, and wherein each reel in the additional reel set is associated with a respective one of the plurality of award symbols.

20. One or more non-transitory, machine-readable media having instructions stored thereon, wherein said instructions, when executed by one or more electronic processors of a gaming system, cause the gaming system to perform operations comprising:
presenting, via a presentation assembly, a plurality of reels associated with a first array, said plurality of reels configured to bear a plurality of symbols via the first array;
animating, in a second array positioned above the first array, a plurality of trails, wherein each trail from the plurality of trails has a variable number of trail symbols randomly selected according to a random number generator;
animating, via the second array on top of each trail, a separate one of a plurality of award symbols associated with a plurality of award values presented via a display of the gaming system;
conducting a series of game spins of the plurality of reels, wherein for each of the series of game spins, spinning and stopping the plurality of reels to land a plurality of subsets of the plurality of symbols for presentation via the first array;
in response to conducting each game spin, clipping a portion of trail symbols from one or more of the plurality of trails in the second array, wherein the portion of trail symbols clipped is equivalent to a number of matching ones of the plurality of subsets of the plurality of symbols that landed via the first array;
in response to said clipping, animating a dropping motion of any given one of the plurality of award symbols positioned atop a clipped trail toward a win line at a bottom of the second array; and
in response to detecting that the any given one of the plurality of award symbols reaches the win line, awarding one of the plurality of award values associated with the any given one of the plurality of award symbols.
